(19) United States
(12) Patent Application Publication
(10) Pub. No.: US 2026/0318121 A1
(43) Pub. Date: Oct. 15, 2026

(54) LOCK FOR A MOTOR VEHICLE, IN PARTICULAR A MOTOR VEHICLE DOOR LOCK

(71) Applicant: Kiekert Aktiengesellschaft, Heiligenhaus (DE)

(72) Inventor: Jan FASSEL, Pardubice (CZ)

(73) Assignee: Kiekert Aktiengesellschaft, Heiligenhaus (DE)

(21) Appl. No.: 19/108,612

(22) PCT Filed: Aug. 21, 2023
(86) PCT No.: PCT/DE2023/100612

§ 371 Date: Mar. 4, 2025

(30) Foreign Application Priority Data
Sep. 9, 2022 (DE) 10 2022 122 958.0

(51) Int. Cl. E05B 77/06

(52) U.S. Cl. CPC E05B 77/06

(57) ABSTRACT

The invention relates to a lock (1) for a motor vehicle, in particular a motor vehicle door lock (1), having a locking mechanism (2) with a rotary latch (4) and a pawl (3); an actuation lever (11, 12), by means of which the locking mechanism (2) can be unlocked; and a locking lever (20), by means of which the locking mechanism (2) can be prevented from unlocking on the basis of the effect of a pulsed vehicle acceleration (F), wherein the locking lever (20) can be brought into direct engagement with the pawl (3).

The invention relates to a lock for a motor vehicle, in particular a motor vehicle door lock, having a latching mechanism with a rotary latch and a detent pawl, an actuation lever, wherein the latching mechanism can be unlatched by means of the actuation lever, and a catch lever, wherein the latching mechanism can be prevented from unlatching by means of the catch lever, subject to an impact from an impulse-type acceleration of the vehicle.

Today's cars integrate more and more passenger safety systems aimed at protecting the vehicle's users in case of an accident. These safety systems may be integrated directly into the lock or locking system of the motor vehicle. This eliminates the need for additional systems, which might, for example, be located in the door handle. Thus, the lock has an additional function, namely to prevent an unintended opening of the lock even in case of an accident. This might occur, for example, if a door handle is actuated via an impulse-type vehicle acceleration due to an accident, so that an opening motion is transferred from the door handle to the locking system. To prevent an unintended opening of the lock in this case, integrated safety systems have become known.

In a lock for a motor vehicle, latching mechanisms are usually installed that comprise a rotary latch and a detent pawl. The latching mechanism in the lock acts together with a striker plate that is fastened either to the body of the motor vehicle or to the door, hatch, sliding door, etc. The relative motion between the striker plate and the rotary latch causes the rotary latch to be pivoted, while the detent pawl, usually under prior spring tension, simultaneously comes into mesh with the rotary latch.

There are one-step or two-step latching mechanisms, depending on the embodiment, which may then have a pre-latched and/or a main latched position. The detent pawl is preferably brought into mesh with the rotary latch under spring tension. For unlatching, that is, releasing the detent pawl from the rotary latch, the detent pawl must be brought out of mesh with the rotary latch by means of an actuation lever, whereby the rotary latch is moved from the latched position to an opening position. The movement of the rotary latch usually occurs in this case by means of a spring element and/or based on a tensile load that results from the striker plate in combination with a door gasket.

The actuation lever can be an interior actuation lever or an exterior actuation lever, for example. By means of the actuation lever, the latching mechanism can be unlatched.

In DE 10 2014 001 490 A1, a mass-inertia-based actuation system for a release mechanism to unlatch a latching mechanism was disclosed. In it, an actuation lever interacts with a coupling lever that is mounted in a pivoting manner on a release lever. Here, a spring seated on the actuation lever meshes with the coupling lever, thereby making it possible for the coupling lever to engage when the actuation lever is operated. In the engaged condition, a latching mechanism can be unlatched by means of a release lever. In addition, a locking lever is provided, which is capable of being disengaged by means of the coupling lever as well as in the event of an inertia-based accident.

A groundbreaking state of the art can be seen in DE 103 45 104 A1. The publication discloses a motor vehicle door lock that is equipped with a latching mechanism, and also with at least one actuation lever to trigger the latching mechanism, and with a catch lever that blocks the actuation lever in case of specified vehicle accelerations. In this way, the catch lever in its triggered position prevents an unintended opening of the latching mechanism. The catch lever is positioned on a release lever and slides past a guiding surface.

Under spring tension, the catch lever is in adjoining contact with the guiding surface. If a force acts on the motor vehicle lock in the event of an impulse-type acceleration of the motor vehicle, the catch lever will be pivoted out and will reach an end stop positioned on the guiding surface. This end stop prevents the motion or blocks the motion of the release lever, so that an unintended opening of the motor vehicle lock can be prevented.

The safety systems disclosed in the prior art have generally retained their value. However, the demands placed on safety systems are steadily rising. In particular, electromobility in vehicles makes it so that large and ever larger batteries must be included in motor vehicles. These large batteries cause an increase in weight in motor vehicles, which leads to greater momentum in crashes. To keep up with the demands of greater weights and rising impulse-type vehicle accelerations in crashes, solutions must be provided to make safety systems available to protect passengers in these cases as well. This is what the invention addresses.

The inventive task is to provide an improved lock for a motor vehicle. An additional inventive task is to provide a mass-based actuation system for a motor vehicle lock, with which a secure locking of the lock can be guaranteed and an unintended opening of the lock can be prevented even in a case of heightened momentum.

The task is solved according to the invention by the characteristics of the independent Patent Claim 1. Advantageous designs of the invention are indicated in the dependent claims. It is hereby noted that the embodiments described below are not restrictive, but rather there are any number of possible variants of the characteristics described in the description, dependent claims and drawings.

According to Patent Claim 1, the inventive task is solved by providing a lock for a motor vehicle, in particular a motor vehicle door lock, that has a latching mechanism with a rotary latch and a detent pawl, an actuation lever, wherein the latching mechanism can be unlatched by means of the actuation lever, and a catch lever, wherein the latching mechanism can be prevented from unlatching by means of the catch lever, subject to an impact from an impulse-type acceleration of the vehicle, and wherein the catch lever can be brought directly into mesh with the detent pawl. By the inventive design of the motor vehicle lock, the possibility is now created to provide a motor vehicle lock, with which an unlatching of the latching mechanism can be prevented independently from the actuation lever chain. Directly accessing the detent pawl makes it possible in this case for the latching mechanism to remain closed, i.e., locked, in case of an acceleration of the actuation lever. This is independent of the interior actuation lever or the exterior actuation lever, since the actuation levers can cause an unlatching of the latching mechanism independently from one another. By means of the inventive design, if the catch lever is brought directly into mesh with the detent pawl, then the latching mechanism itself is secured by means of the catch lever, and thus the movements of the actuation levers have no influence on any unlatching of the latching mechanism in case of an accident.

Whenever the invention refers to a lock for a motor vehicle, this means locking systems that are deployed in a motor vehicle. These can be locking system [sic] or vehicle locks for hoods, side doors, sliding doors, hatchback locks, covers or other locking systems in the motor vehicle, basically anywhere that pivoting or sliding components must be securely positioned and held during operation of the motor vehicle. Preferably, the invention relates to motor vehicle door locks. The reason for this is that, in case of an accident and particularly a side collision, forces are generated on the motor vehicle that can cause the exterior door handle or the interior door handle to move. Usually, a coordinate system is placed in the motor vehicle, in which the lengthwise direction is called the x-direction and the crosswise direction is called the y-direction, and the vertical is called the z-direction.

A side collision thus causes an impulse-type application of force to the motor vehicle in the y-direction. If, therefore, in an accident, a momentum is applied to the motor vehicle in a side collision, then a door handle, particularly an exterior door handle, can be accelerated and, if the door is unlocked, it may cause the latching mechanism to be unlatched. The invention counteracts this unwanted opening of the lock, in that, when there is a force against the motor vehicle in the y-direction, the catch lever counteracts this momentum and moves the catch lever in the direction of the detent pawl. Since the catch lever in this case is moved by virtue of mass-inertia, the catch lever can also be called a mass-inertia lever.

The lock has a latching mechanism with a rotary latch and a detent pawl. In the present case, the invention relates to a lock with a latching mechanism comprising a rotary latch and a detent pawl. The rotary latch and detent pawl preferably interact directly, although can also interact with the detent pawl via a connector or a connecting link. The connector can be positioned on one side of a lock case and be firmly connected via an axle with the rotary latch connected on an opposite side of the lock case.

In a preferred embodiment of the invention, the lock has an exterior actuation lever and an interior actuation lever, with the exterior actuation lever and the interior actuation lever acting directly on the detent pawl. The present inventive lock is designed with a simple structure, inasmuch as intermediate lever mechanisms, such as a release lever, are dispensed with. The interior actuation lever and the exterior actuation lever are accommodated in the motor vehicle lock in a pivoting manner, and are mounted in the motor vehicle lock in a pivoting manner, for example, directly in a lock case or indirectly via an axle. In addition, a locking lever can be provided, wherein it can be provided that the exterior actuation lever is placed out of mesh by means of the locking lever.

For this purpose, the exterior actuation lever can be accommodated in a sliding manner in the bearing point and can be brought out of mesh with the detent pawl using the locking lever by sliding.

In another design variant, the catch lever is mounted in a pivoting manner in the lock, in particular in the lock case. The lock has a lock case, wherein the lock case is preferably designed in an L-shape. A first leg of the L-shape carries the latching mechanism and is preferably positioned along a door rabbet in, for example, a side door of a motor vehicle. This positioning makes it possible for the rotary latch to interact with a striker plate positioned, for example, on a B-pillar of a motor vehicle. Another leg of the lock case extends at a right angle to the first leg and serves as the bearing for the interior actuation lever and the locking lever. The exterior actuation lever is preferably mounted in a pivoting and sliding manner on the first leg, namely the leg carrying the latching mechanism. The lock case is preferably formed in one piece from a sheet plate. Accommodating the catch lever in the first leg of the lock case makes it possible to mount the catch lever and bring it into mesh with the latching mechanism or the detent pawl with the least possible design complexity once again. Thus, a design of simple structure can be produced with the least possible proportion of required components.

It can be advantageous if the catch lever can be held in a starting position by means of a spring element, in particular a spiral spring. The catch lever is held in the lock case in a manner allowing pivoting motion and is mounted in the lock case, for example, by means of a swivel pin. If the catch lever is mounted on the swivel pin, then the catch lever can be positioned in the motor vehicle lock by means of the spring element. Besides the task of positioning the catch lever, the spiral spring or spring element has another task. The spiral spring holds the catch lever in its starting position. If the motor vehicle lock and thus the motor vehicle has a force applied to it due to an impact, then the mobility of the catch lever can be configured by means of the spring element.

In particular, the linear momentum, at which the catch lever or the mass-inertia element comes into mesh with the detent pawl, can be configured by means of the spring element. The spiral spring is thus a functional element, by which the force triggering the meshing of the catch lever with the latching mechanism can be set. Preferably, a spiral spring is used for this purpose, since a spiral spring can be easily integrated into or adapted to a pivoting component.

The spiral spring can prop itself with its legs against the lock case on one side and against the catch lever itself on the other side. In an impulse-type vehicle acceleration, the catch lever can be pivoted into a range of motion of the detent pawl. Through this inventive design of the lock, the possibility exists that the catch lever can follow the linear impulse immediately. In particular, the pivoting bearing in combination with the spring element makes it possible for the pivoting motion to be initiated as a function of the linear momentum. In any case, the pivoting motion can follow the linear impulse immediately, so that even an instantaneous motion and thus an instantaneous blocking of the latching mechanism can be enabled and configured, including in the case of large impulse-type motor vehicle accelerations. Moreover, the pivoting bearing offers a solution of simple design for accommodating the catch lever.

In an advantageous manner, the catch lever can have at least one stop face, wherein the stop face can be brought into mesh with the detent pawl. The catch lever interacts directly with the detent pawl. If the catch lever has a stop face, then the catch-locking depth of the catch lever into the detent pawl can be limited or configured. The stop face additionally offers the advantage that it is possible to achieve a secure mesh with the detent pawl. If the stop face is in adjoining contact with the detent pawl, then the catch lever blocks the motion of the detent pawl. Preferably, the stop is positioned at one axial end of the catch lever and is designed in one piece on the catch lever as an extension of the catch lever. Thus, the catch lever has at least one shoulder, with the shoulder defining the width of the catch-locking depth into the detent pawl.

The stop face can define the mesh conditions with the detent pawl, on the one hand, but the stop face can also serve as a stop face in the starting position of the catch lever.

In a preferred embodiment of the invention, then, an advantage is produced when a lock cylinder is positioned on the lock in such a way that the exterior actuation lever can be operated by means of the lock cylinder. The exterior actuation lever is mounted in a pivoting manner in the motor vehicle lock. A lock cylinder positioned on the motor vehicle door interacts with the exterior actuation lever directly or by means of a slider. By means of the slider, the exterior actuation lever can be shifted from a locked position into an unlocked position. For this purpose, the slider positioned on the lock cylinder interacts with a folded edge on the exterior actuation lever, so that the pivoting motion of the lock cylinder results in a linear motion of the exterior actuation lever. Thus, the exterior actuation lever can be shifted by means of the lock cylinder into an unlocked or a locked position. In an unlocked position, the exterior actuation lever is brought out of mesh with the detent pawl. This once again shows the simple structural design of the motor vehicle lock and hence the advantage that great functionality can be provided in a motor vehicle lock using means of the simplest structural design.

If the exterior actuation lever is positioned by means of a compression spring, for example if it is held in a starting position by means of the compression spring, another design variant of the invention can be achieved. The exterior actuation lever can be held in its starting position by the compression spring. The compression spring offers a favorable structural design means to stabilize a starting position of the exterior actuation lever. Thus, with means of the simplest structural design, a motor vehicle lock can be provided that, in combination with the catch lever, has great functionality and crash safety.

It can also be advantageous if the detent pawl is in mesh with one another by means of a spring element, in particular by means of a tension spring.

The detent pawl can be in connection with the detent pawl [sic] via a spring element or indirectly with the rotary latch via a connector. By means of the tension spring, on the one hand, the detent pawl can be held in adjoining contact with the rotary latch or the connector, and on the other hand, the tension spring can serve to open the rotary latch or to move the rotary latch in the direction of opening. Thus, the tension spring has a dual function. The tension spring serves, on the one hand, to position the detent pawl and, on the other hand, to assist in moving the rotary latch.

The inventive design of the motor vehicle lock makes it possible to provide a high degree of safety in the motor vehicle lock with means of the simplest structural design. In particular, the motor vehicle lock can be adapted to the heightened demands of the automotive industry and, in particular, the associated higher weights of electric or hybrid vehicles. The catch lever, as a means of simple structural design, in combination with a spring element, can be adapted in this case to the specific demands in the motor vehicle.

The invention is described below in detail with reference to the attached drawings based on a preferred embodiment. The principle applies, however, that the embodiment does not limit the scope of the invention, but only presents an advantageous design form. The presented characteristics can be realized individually or in combination with other characteristics of the description or with the patent claims individually or in combination.

In the Attached Drawings:

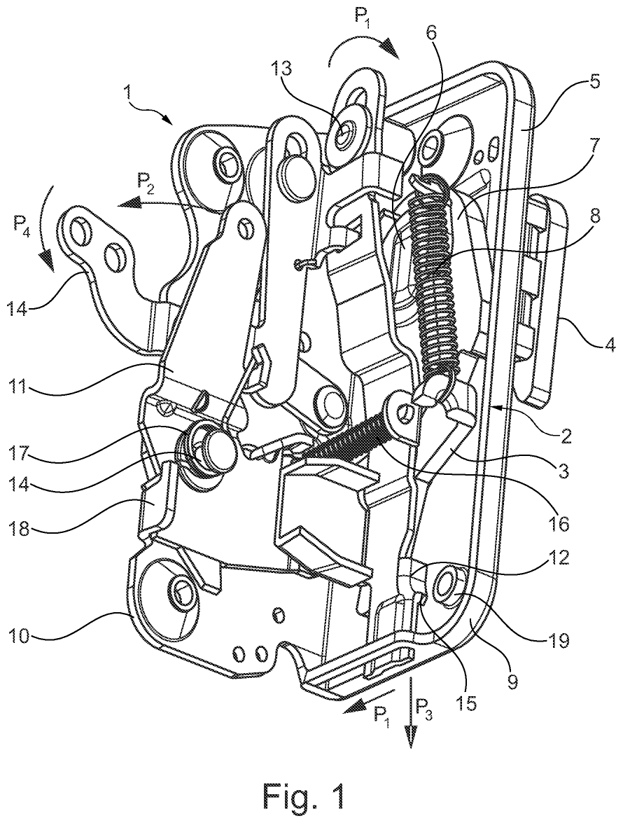

FIG. 1 shows a three-dimensional view of the mechanism of the motor vehicle lock,

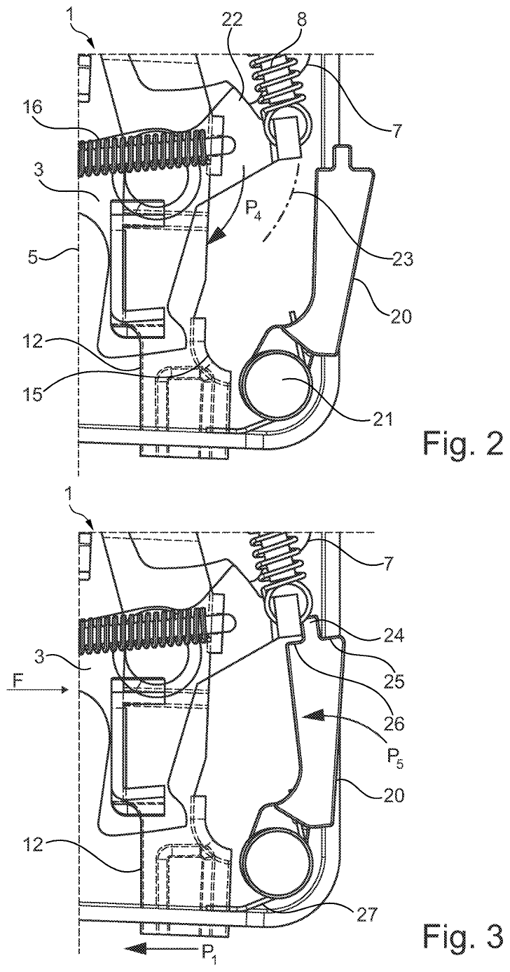

FIG. 2 shows a detailed view of the motor vehicle lock of FIG. 1 with a catch lever, wherein the catch lever is depicted out of mesh with the latching mechanism, and FIG. 3 shows a view of the catch lever in the motor vehicle lock, wherein the catch lever is depicted in a blocking position.

FIG. 1 shows a motor vehicle lock 1 in a three-dimensional view, in which only the parts of the lock necessary for the description are depicted. The motor vehicle lock has a latching mechanism 2 with a detent pawl 3 and a rotary latch 4. Rotary latch 4 is positioned outside of a lock case 5 and firmly connected with a connector 7 via an axle 6. All components, rotary latch 4, axle 6 and connector 7, are connected to one another as steel parts and inseparably. Detent pawl 3 acts reciprocally with connector 7, so that one or two latched positions can be realized in latching mechanism 2. Connector 7 and thus rotary latch 4 [sic] are connected with one another via a spring element 8. Spring element 8 is preferably designed as a tension spring, so that detent pawl 3 is present in motor vehicle lock 1 preloaded with spring tension in the direction of connector 7. Latching mechanism 2 and in particular detent pawl 3 and rotary latch 4 are accommodated in lock case 5 in a pivoting or rotatable manner. Lock case 5 is designed in an L-shape, wherein latching mechanism 2 is accommodated on a first leg 9 and a second leg 10 extends at a right angle to first leg 9.

To unlatch latching mechanism 2, either interior actuation lever 11 or exterior actuation lever 12 can be moved. In this process, exterior actuation lever 12 is pivoted clockwise around axle 13 in the direction of arrow P1 and interior actuation lever 11 is moved around axle 14 in the direction of arrow P, in order respectively to contact detent pawl 3 and bring it out of mesh with rotary latch 4 and/or connector 7. With locking lever 14, exterior actuation lever 12 can be slid linearly in the direction of arrow P3, by which a shoulder 15 on exterior actuation lever 12 comes out of mesh with detent pawl 3, so that any operation of exterior actuation lever 12 does not bring about an unlatching of latching mechanism 2. Exterior actuation lever 12 itself can be held in its starting position depicted in FIG. 1 by means of a compression spring.

Interior actuation lever 11 in turn is preloaded under spring tension by means of a spiral spring 17, wherein the preloading spring tension is in adjoining contact in the clockwise direction, so that interior actuation lever 11 is in adjoining contact preloaded under spring tension with a folded edge 18 of lock case 5. Any operation of interior actuation lever 11 in the direction of arrow P2 must consequently occur against the force of spiral spring 17. The operation or locking of motor vehicle lock 1 is done by moving locking lever 14 through a pivoting motion of locking lever 14 in the direction of arrow P4, with locking lever 14 in turn being accommodated in a pivoting manner in other leg 10 of motor vehicle lock 1. A pivoting motion of locking lever 14 in the direction of arrow P4 brings about a linear movement of exterior actuation lever 12 in the direction of arrow P3.

Also visible in FIG. 1 is a bearing point 19, in which a catch lever 20 can be accommodated, mounted in a pivoting manner. The bearing point in this embodiment is formed as one piece from lock case 5, so that a bearing for catch lever 20 is obtained that is favorable in terms of structural design. The function of catch lever 20 is described in the following FIGS. 2 and 3.

FIG. 2 shows an enlarged depiction of the motor vehicle lock in the area of the bearing point of catch lever 20. The same parts are labeled with the same reference numbers. Catch lever 20 is mounted in motor vehicle lock 1 in a pivoting manner around axle 21. In FIG. 2, catch lever 20 is shown in its starting position, so that an operation of exterior actuation lever 12 brings about a pivoting of detent pawl 3 in the direction of arrow P4, that is, in the clockwise direction. In this process, shoulder 15 interacts with detent pawl 3, so that detent pawl 3 is freed from meshing with connector 7. It is depicted in FIG. 2 that detent pawl 3 is in adjoining contact with a mesh surface or latching surface 22 on connector 7, so that rotary latch 4 is held in a latched position. An operation of exterior actuation lever 12 therefore causes rotary latch 3 [sic] to be brought out of mesh with connector 7, in that detent pawl 3 is pivoted in the direction of arrow P4.

This pivoting motion is conveyed into detent pawl 3 by shoulder 15. Catch lever 20 lies outside of the swiveling range 23 of detent pawl 3.

If an accident, for example, generates a force F that impacts motor vehicle lock 1 through an impulse-type acceleration, then the mass-inertia of catch lever 20 causes catch lever 20 to move in the direction of arrow P5, by means of which a stop 24 comes into adjoining contact with detent pawl 3. A momentum-laden motion of an exterior door handle, for example, would have the result that, if motor vehicle lock 1 were unlocked, exterior actuation lever 12 would move in the direction of arrow P1, which would cause detent pawl 3 to be lifted away from the rotary latch and in particular from connector 8. This pivoting motion of rotary latch 3 [sic] is prevented by catch lever 20 in the position depicted in FIG. 3. Depending on the position of shoulder 24 at the axial end of catch lever 20, an overlap 26 is produced between detent pawl 3 and catch lever 20.

The motion of catch lever 20 is due to inertia and acts against the force of a spring element 27, with spring element 27 being preferably a spiral spring 27 as shown in the embodiment. The movement of the catch lever, caused by inertia, is in opposition to force F from the impulse-type acceleration, for example due to a collision impact from another motor vehicle, wherein catch lever 20 is to be designed with reference to the mass-inertia momentum and to spring element 27. In any case, catch lever 20 prevents an unwanted opening of latching mechanism 2, with latching mechanism 2 remaining latched regardless of any movement of interior actuation lever 11 and/or exterior actuation lever 12.

Latching mechanism 2 is blocked by catch lever 20, regardless of the movement of actuation levers 11, 12.

In this way, a motor vehicle lock 1 can be configured in the motor vehicle lock [sic] with great reliability and subject to the required impulse-type acceleration, that is, the multiple of the gravitational acceleration, in that the mass of catch lever 20, overlap 26, and the spring constant of spring element 27 are adapted to meet the requirements.

### LIST OF REFERENCE SIGNS

1 Motor vehicle lock
2 Latching mechanism
3 Detent pawl
4 Rotary latch
5 Lock case
6, 13, 21 Axle
7 Connector
8, 27 Spring element
9, 10 Leg
11 Interior actuation lever
12 Exterior actuation lever
14 Locking lever
15 Shoulder
16 Compression spring
17 Spiral spring
18 Folded edge
19 Bearing point
20 Catch lever
22 Latching surface
23 Swiveling range
24 Stop
25 Axial end
26 Overlap
P1, P2, P3, P4, P5 Arrow
F Force

1. A lock for a motor vehicle, the lock comprising:
a latching mechanism with a rotary latch and a detent pawl,
an actuation lever, wherein the latching mechanism is configured to be unlatched by the actuation lever, and
a catch lever, wherein the latching mechanism is configured to be prevented from unlatching by the catch lever, subject to an impact from an impulse-type vehicle acceleration of the motor vehicle, and wherein the catch lever is configured to be brought directly into mesh with the detent pawl.

2. The lock of claim 1,
wherein the actuation lever includes an exterior actuation lever and an interior actuation lever, and
wherein the exterior actuation lever and the interior actuation lever are configured to act directly on detent pawl.

3. The lock of claim 1 further comprising a lock case, wherein the catch lever is mounted in a pivoting manner in the lock case.

4. The lock of claim 1 further comprising a first spring element, wherein the catch lever is configured to be held in a starting position by the first spring element.

5. The lock of claim 1, wherein the catch lever is configured to be pivoted into a range of motion of the detent pawl in the event of the impulse-type vehicle acceleration of the motor vehicle.

6. The lock of claim 1, wherein the catch lever has at least one stop face, and wherein the at least one stop face is configured to be brought into mesh with detent pawl.

7. The lock of claim 2 further comprising a lock cylinder, wherein the lock cylinder is positioned on the lock in such a way that the exterior actuation lever is configured to be operated by the lock cylinder.

8. The lock of claim 2 further comprising a compression spring, wherein the exterior actuation lever is configured to be positioned in a starting position by the compression spring.

9. The lock of claim 1 further comprising a second spring element, wherein the detent pawl is in mesh with the rotary latch by the second spring element.

10. The lock of claim 1, wherein the rotary latch has a connector.

11. The lock of claim 10, wherein the rotary latch further includes an axle, and wherein the rotary latch and the connector are connected via the axle.

12. The lock of claim 10, wherein the detent pawl acts reciprocally with the connector such that at least one latching position is achievable in the latching mechanism.

13. The lock of claim 4, wherein the first spring element is a spiral spring.

14. The lock of claim 5, wherein the range of motion is a swiveling range.

15. The lock of claim 9, wherein the second spring element is a tension spring.

16. The lock of claim 1, wherein the latching mechanism is blocked by the catch lever, regardless of a movement of the actuation lever.
